(19) United States
(12) Patent Application Publication
(10) Pub. No.: US 2006/0208381 A1
(43) Pub. Date: Sep. 21, 2006

(54) Process for simulating molded brick

(76) Inventor: Jeffrey L. McNear, Greenbrae, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/378,931

(22) Filed: Mar. 16, 2006

Related U.S. Application Data
(60) Provisional application No. 60/662,972, filed on Mar. 16, 2005.

(51) Int. Cl. B28B 1/08; B29C 47/00; B28B 3/00; B28B 1/00

(52) U.S. Cl. 264/69; 264/638; 264/679; 264/119

(57) ABSTRACT

Brick is normally extruded and sized in length, typically by extrusion through a die having the section of the brick followed by cutting the extruded section into the length desired for the brick. Before the brick is dried and fired, but after extrusion and cutting to length, the brick is randomly deformed, preferably by tumbling, to impart to its respective surfaces random appearance. Glazes and sand can be added during the tumbling process. After having its surfaces randomly deformed, the brick is partially straightened, preferably to impart to the length and width of the brick a uniform overall nominal dimension. There results, after drying and firing of the product, a brick having overall dimensionality but with a surface patina characteristic of so-called antique brick.

### CROSS-REFERENCES TO RELATED APPLICATIONS

This is a continuation and claims the priority of provisional patent application No. 60/662,972 filed Mar. 16, 2005 for a Process For Molding Imitation Brick With Patina.

### BACKGROUND OF THE INVENTION

This invention relates to so-called antique or form-molded brick. More particularly, a process is disclosed wherein brick prior to curing is randomly tumbled, straightened to produce overall alignment with the tumbled irregularities only partially removed, and thereafter dried and fired to form a brick building product having artistic surface variation from brick to brick.

Brick is an ancient building material, and its method of manufacture has evolved along with humanity's other technological accomplishments. Until the last century or so, bricks were formed by hand, using wood molds and primitive kilns, and the bricks produced in this way had the subtly irregular shapes and colors which are the hallmark of historic bricks. Modem brick factories can now mass produce bricks that are exactly alike and perfect in shape and color, but there is still a demand for bricks with the irregular appearance of hand-made bricks. Many methods are employed by modem factories trying to recreate the hand-made look with modem mechanized equipment. This invention provides a novel way to reproduce the hand-made look.

“Historic” brick has a distinctive appearance or “patina” over its modem counterpart. Specifically, the surface of such historic brick is irregular in color and textures, although in overall length, width and depth, historic brick has sufficient dimensional stability to enable sound structures to be created by the skilled bricklayers and masons of the past.

The reason that historic brick had its irregular appearance resulted directly from the irregular process by which the brick was formed. Typically, the brick was formed in a four-sided mold with the bottom of the mold resting on a surface, the top side of the mold squared off by the brick maker, and the molded brick removed by hand from the mold for curing. Sand was used as a lubricant in such molds. Further, produced glazes on the brick were non-uniform uniform. This handling of the brick gave the brick structures made from such brick a distinctive irregular appearance or patina.

Modem brick does not have such a distinctive appearance. Modem brick has square and regular surfaces. Buildings made from such brick present the familiar regular brick patterns. As the sides are all uniform, the laid brick has a correspondingly uniform appearance.

With the modem methods of manufacture, and regular brick surfaces which they produce, there has arisen a taste for the irregular brick surfaces of old. Specifically, in many cases where brick structures containing the old hand-formed brick were destroyed or razed, the brick was salvaged and reused—usually at considerable expense. Accordingly, this invention is aimed at artificially creating the surface characteristics or “patina” of so-called antique bricks.

### BRIEF SUMMARY OF THE INVENTION

In modem factories, brick is usually extruded and cut to the desired shape and length. At this stage, before the bricks are dried and fired, the bricks are firm but malleable. According to the process of the present invention, the malleable bricks are first deformed by tumbling them in a drum, or by other means, to produce dents, bends, bulges and scrapes, etc. The deformed bricks are then subjected to another step, where rollers or other means push the bricks back to their approximate, original dimensions. This reforming does not completely restore the original shapes, and the bricks so processed typically have rounded edges and other subtle irregularities suggestive of actual historic brick. Sand, engobes and other colorants can be added during this process to impart different appearances to the bricks. After this process, the bricks are dried and fired in the usual manner.

Additional optional steps that can be employed according to the present invention can include the adding of glazes and sand during the tumbling process. After having its surfaces randomly deformed, the brick is then partially straightened to give the brick its approximate length and width.

Thus, bricks made according to the present invention have the desired overall dimensionality and the surface characteristic of so-called antique brick.

### BRIEF DESCRIPTION OF THE DRAWINGS

FIG. 1 is a regular moist clay-type brick being introduced to a tumbler for imparting the deformed surface appearance to the undried and pliable brick;

FIG. 2 illustrates the brick discharged from the tumbling process with the overall surfaces being randomly deformed and having surface irregularities;

FIG. 3 illustrates the brick of FIG. 2 being passed between rollers to return nominal dimensionality to the brick but maintain the respective randomly deformed surfaces of the brick; and

FIG. 4 illustrates the brick of FIG. 2 being released from between paired planar and opposed surfaces to impart irregular surfaces but overall nominal dimensionality to the brick.

### DETAILED DESCRIPTION OF THE INVENTION

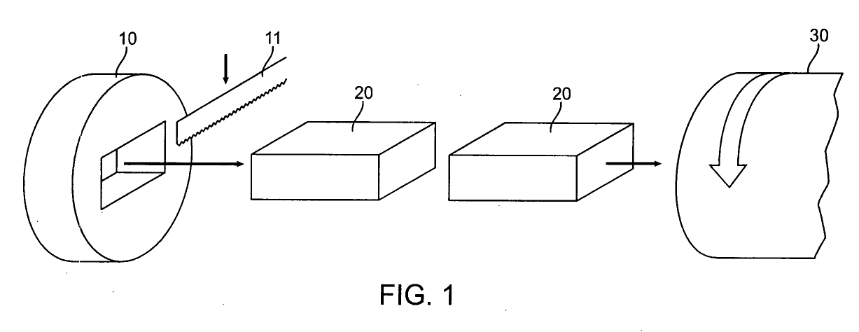

Referring to FIG. 1, a die 10 has clay, shale or other brick forming material extruded through it with the section of the desired brick 20. Cutting implement 11, such as a knife or a cutting wire, cuts the extruded clay brick material into desired lengths, producing undried and pliable brick masses 20. These undried and pliable brick masses 20 are then introduced to rotating tumbler 30.

Rotating tumbler 30 will typically have a group of wet and pliable clay brick masses 20 within. Rotation for a sufficient interval to produce random deformations of at least the surfaces should occur.

It will be understood that other deforming processes can be used, although tumbling is presently preferred. For example, objects may randomly impact the surfaces—such as randomly sized stones or balls. Further, chain beating can be used. In short, any treatment that deforms the surface of the wet brick mass will suffice.

If other effects are desired, other constituents can be added during the tumbling process. For example, sand can be added. Glazes can be added of varying kind, mixture and the like. The tumbling process uses the sand to texture the brick, and the glazes—either in liquid or solid form—adhere to the surface of the brick prior to drying and firing.

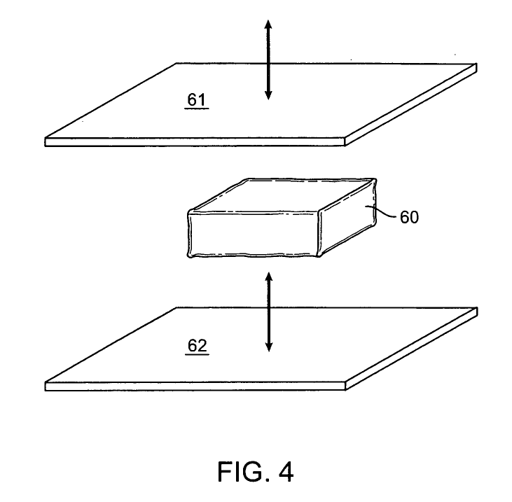

Accordingly, and after tumbling, some effort must be made to maintain overall dimensionality of the produced product. FIGS. 3 and 4 illustrate in an exemplary fashion two such measures.

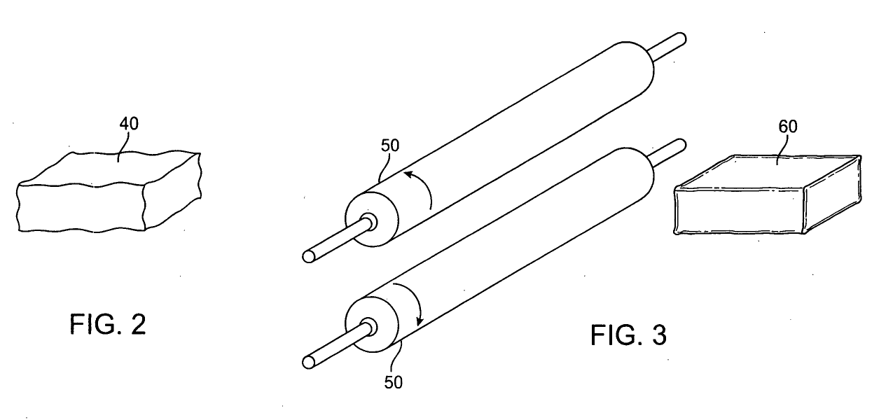

Referring to FIG. 2, an undried, unfired and pliable brick mass 20 after tumbling is illustrated at 40. In the relatively wet, pliable and randomly tumbled brick mass 40, it is clear that, at the very least, the overall section of the brick mass 40 has been deformed by the tumbling process.

Referring to FIG. 3, the undried, pliable and tumbled brick mass 40 is passed between a pair of rollers 50 to impart a substantially uniform section to the uncured, pliable and re-dimensioned brick mass 60. The drawings show a single pass along paired opposite surfaces of the brick. Only two such rollers are illustrated in the drawings. However, any series of rollers with changing alignment will suffice. For example, successive horizontally aligned rollers can be followed by successive vertically aligned rollers. Further, pairs of horizontally aligned and pairs of vertically aligned rollers can exist. Further, brick can be conveyed along a conveyor with a single roller overlying the conveyor. Numerous alternative reforming processes can be used.

Referring to FIG. 4, paired flat, planar surfaces compress uncured, pliable and re-dimensioned brick mass 60 between them. This compression restores the overall dimensionality to the patina of the brick product of this invention. Further, either multiple compression steps, reorienting of the brick for the next compression step, or compressing even a single surface at a time of the brick can provide restoration of the necessary overall dimensionality.

It should be understood that the process and apparatus of FIGS. 3 and 4 do not completely straighten out uncured, pliable and re-dimensioned brick mass 60. Instead, only preservation of the nominal dimensionality results. Thus, random irregularities on the surfaces of the brick will remain, which gives the brick the characteristics of antique brick patina.

What is claimed is:

1. A process of producing brick having a randomly deformed surface simulating molded brick comprising the steps of:
shaping undried hardenable brick forming material into an undried brick having substantially an overall size and shape of a desired end product brick;
randomly deforming a plurality of surfaces of the regular undried brick to form a randomly deformed undried brick;
reforming the randomly deformed undried brick to at least approximately restore original dimensions to the undried brick with the surfaces of the undried brick retaining some of the random deformations; and
drying and firing the randomly deformed and thereafter reformed undried brick to produce the end product in the form of a hardened brick having random surface variation.

2. The process of claim 1 wherein shaping comprises extruding the brick forming material and giving the material a desired cross-section, and severing an undried brick from the extruded material

3. The process of claim 2 wherein extruding the brick forming material comprises extruding at least one of clay and shale.

4. The process of producing brick having a randomized surface simulating molded brick according to claim 1 wherein randomly deforming includes tumbling the undried brick.

5. The process of producing brick having a randomized surface simulating molded brick according to claim 1 wherein reforming includes passing the randomly deformed undried brick mass past at least one roller in contact with the undried brick mass.

6. The process of producing brick having a randomized surface simulating molded brick according to claim 1 wherein reforming includes pressing the randomly deformed undried brick between flat surfaces.

7. The process of producing brick having a randomized surface simulating molded brick according to claim 1 including bringing sand in contact with at least the plurality of surfaces during randomly deforming to change a surface texture of the randomly deformed undried brick mass.

8. The process of producing brick having a randomized surface simulating molded brick according to claim 1 including applying at least one of a glaze and engobes to the plurality of surfaces during randomly deforming the uncured brick to produce glaze coating that is visible on the hardened brick after firing.

9. The product of the process of claim 1.
